(19) United States
(12) Patent Application Publication
(10) Pub. No.: US 2022/0385769 A1
(43) Pub. Date: Dec. 1, 2022

(54) COLOR PROFILE AND SUBSTRATE MISMATCH DETERMINATIONS

(71) Applicant: HEWLETT-PACKARD DEVELOPMENT COMPANY, L.P., Spring, TX (US)

(72) Inventors: Antonio Gracia Verdugo, Sant Cugat del Valles (ES); Marina Cantero Lazaro, Sant Cugat del Valles (ES); Andrei Alexandru Dafinoiu, Sant Cugat del Valles (ES)

(21) Appl. No.: 17/303,340

(22) Filed: May 27, 2021

(51) Int. Cl. H04N 1/00; H04N 1/60

(52) U.S. Cl. CPC H04N 1/00029; H04N 1/00023; H04N 1/603; H04N 1/6094

(57) ABSTRACT

In some examples, a system compares information of a color profile for an imaging device to color information relating to a type of substrate on which an image is to be formed. Based on the comparing, the system determines a mismatch between the color profile and the type of substrate. The system initiates a remedial action to address the mismatch.

### BACKGROUND

Imaging devices are able to output images having colors in respective color spaces. Examples of imaging devices include output imaging devices such as display devices, printers, or other types of devices that are able to produce outputs for perception by users or other entities. Imaging devices can also include input imaging devices, such as scanners, cameras, and so forth, that can acquire an input image based on a physical object.

### BRIEF DESCRIPTION OF THE DRAWINGS

Some implementations of the present disclosure are described with respect to the following figures.

FIG. 1 is a block diagram of an arrangement that includes a system to identify a mismatch between a color profile and a type of substrate used by an imaging device, according to some examples.

FIG. 2 is a flow diagram of a calibration process according to some examples.

FIG. 3 is a graph showing gamuts according to some examples.

FIG. 4 is a block diagram of a storage medium storing machine-readable instructions according to some examples.

FIG. 5 is a block diagram of a system according to some examples.

FIG. 6 is a flow diagram of a process according to further examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Color profiles can include information that describe color characteristics of an imaging device (either an input imaging device or an output imaging device) or of a given color space. For example, the color profile can refer to a range of colors (also referred to as a gamut) that an imaging device is capable of acquiring or outputting. A gamut of a display device can refer to the range of colors that the display device is capable of displaying. A gamut of a printer can refer to the range of colors that the printer can print. A gamut of an input imaging device (such as a scanner or camera) can refer to the range of colors that the input imaging device can acquire.

In some examples, color profiles are according to standards provided by the International Color Consortium (ICC). Such color profiles are referred to as ICC profiles. ICC profiles can be used by color management systems, such as in printers, display devices, computers, scanners, cameras, etc., to translate image data between color spaces of different imaging devices, such as between the color space of an input image imaging device and the color space of an output imaging device.

An ICC profile for an imaging device can include information that defines a mapping between the color space of the imaging device and a profile connection space (PCS). For example, the PCS can be in the form of the CIELAB color space, also referred to as the L*a*b* color space defined by the International Commission on Illumination (CIE). As another example, a PCS can include the CIEXYZ color space. Other PCSs can be employed in other examples.

CIELAB is a device-independent color space, and expresses color as three values: L for perceptual lightness, and a and b for the four unique colors of human vision: red, green, blue, and yellow. CIEXYZ is also a device-independent color space, and expresses tristimulus values represented by X, Y, and Z.

Users of imaging devices may not understand or be familiar with the color management employed by imaging devices. In some cases, users may encounter color-related issues in images output by an imaging device that users may not be able to debug or solve. For example, an output imaging device such as a printer or display device may not produce expected colors (e.g., output images may contain colors that seem off, such as a white color having a bluish tint or a black color that is not as dark as expected).

Color characteristics relating to images output by imaging devices that may be of interest to users include gray neutrality and black optical density. Gray neutrality refers to a gray that has an equal mixture of colors within a color spectrum. Black optical density refers to the optical density of the black color. Optical density is a measure of absorbance of a color. A gray neutrality issue can arise if an imaging device is unable to produce a neutral gray. A black optical density issue can arise if the optical density of a black color produced by an imaging device is less than an expected threshold. Gray neutrality and black optical density issues can lead to output images having a white color and a black color that are not as expected.

Color-related issues including gray neutrality and black optical density issues may arise from mismatched ICC profiles and substrates on which output images are to be presented. For example, a printer may be used to print images on various types of substrates, including different types of textiles or other print substrates. In further examples, display projectors may project images onto whiteboards or other forms of substrates. As further examples, substrates of display devices can include an (LCD) display panel, a light emitting diode (LED) display panel, and so forth.

In some examples, a printer that uses a given ICC profile may produce accurate color results in images printed on a given type of substrate. However, if the user were to load a different type of substrate into the printer, the given ICC profile may cause an image printed on the different type of substrate to have color-related issues. Color-related issues may also arise due to variations in characteristics among different substrates of a given substrate type. For example, manufacturing variations may result in substrates of the given substrate type exhibiting variable characteristics that can lead to color-related issues when printing images onto the substrates using a given ICC profile.

In accordance with some implementations of the present disclosure, a system can be used to compare information of a color profile (e.g., an ICC profile) for an imaging device to color information relating to a type of substrate on which an image is to be formed. For example, the information of the color profile can be compared to color information acquired by a sensor (e.g., a spectrophotometer or other type of sensor) that is able to acquire color information of an image produced on a substrate. As another example, the information of the color profile can be compared to information in prior color profiles used for printing onto a given type of substrate. Based on the comparing, the system is able to determine a mismatch between the color profile and the type of substrate, and the system can initiate a remedial action to address the mismatch.

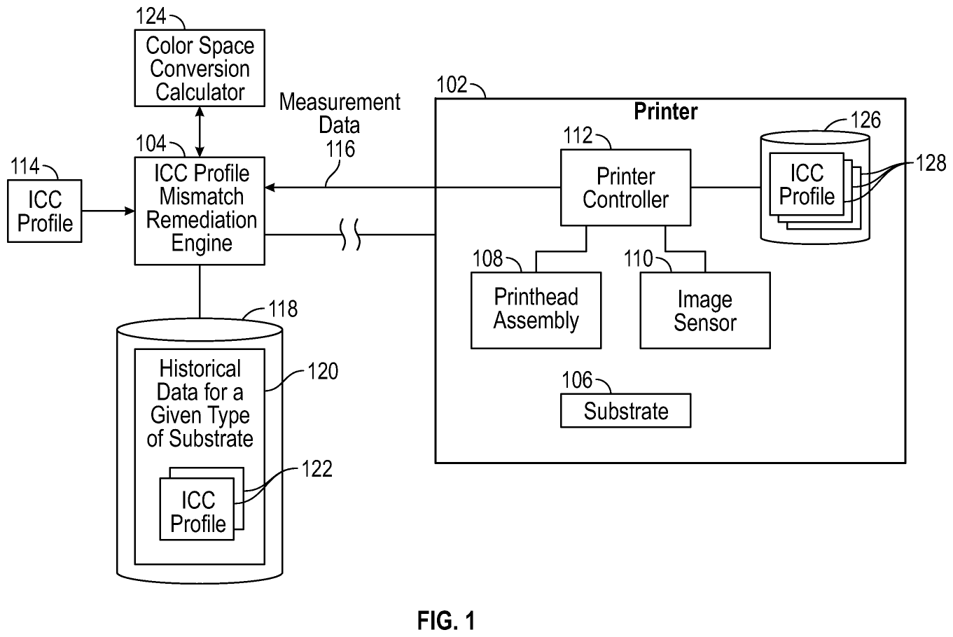

FIG. 1 is a block diagram of an example arrangement that includes a printer 102 and an ICC profile mismatch remediation engine 104. In some examples, the ICC profile mismatch remediation engine 104 is able to identify a mismatch between an ICC profile and a substrate 106 on which the printer 102 is to form an image.

As used here, an “engine” can refer to a hardware processing circuit, which can include any or some combination of a microprocessor, a core of a multi-core microprocessor, a microcontroller, a programmable integrated circuit, a programmable gate array, or another hardware processing circuit. Alternatively, an “engine” can refer to a combination of a hardware processing circuit and machine-readable instructions (software and/or firmware) executable on the hardware processing circuit.

Although examples according to FIG. 1 refer to ICC profile mismatch remediation for a printer, it is noted that in other examples, ICC profile mismatch remediation can be applied to other types of imaging devices, including display devices. As noted above, a substrate onto which an image can be displayed by a display device can include a display panel of a display device or a projection surface (e.g., a whiteboard or other surface) onto which a projector (which is a type of display device) can project.

The printer 102 includes a printhead assembly 108 (including printheads) that is able to dispense inks onto the substrate 106 to form an image on the substrate 106.

The printer 102 also includes an image sensor 110 that is able to acquire measurement information pertaining to a portion of a surface of the substrate 106, such as a portion of the substrate 106 on which an image has been formed by the printhead assembly 108. For example, the image sensor 110 can include a spectrophotometer or other type of sensor that is able to acquire color information of an image on the substrate 106. In further examples, there may be multiple image sensors in the printer 102.

Operations of the printer 102 can be controlled by a printer controller 112, which can include a hardware processing circuit or a combination of a hardware processing circuit and machine-readable instructions. For example, the printer controller 112 can receive input data and control the printhead assembly 108 (and other mechanisms of the printer 102) to produce an image on the substrate 106. The printer controller 112 can also control the image sensor 110 to acquire an image of a portion of the substrate 106.

Although FIG. 1 shows the ICC profile mismatch remediation engine 104 as being separate from the printer 102, in other examples, the ICC profile mismatch remediation engine 104 can be part of the printer 102. In examples where the ICC profile mismatch remediation engine 104 is part of the printer 102, the ICC profile mismatch remediation engine 104 can be implemented as part of the printer controller 112 of the printer 102.

In examples where the ICC profile mismatch remediation engine 104 is separate from the printer 102, the ICC profile mismatch remediation engine 104 can be implemented using a computer (or a number of computers). In such examples, the ICC profile mismatch remediation engine 104 can communicate with the printer 102 over a communications link, such as a wireless link or wired link.

The ICC profile mismatch remediation engine 104 receives an ICC profile 114 that is to be used by the printer 102 for printing an image onto the substrate 106. For example, the printer controller 112 can include a color management system that uses the ICC profile 114 to translate between color spaces as part of a print operation.

An ICC profile can contain a set of tables (a “set” can include a single table or multiple tables) used to calculate between a device color space (e.g., a color space of the printer 102) and a PCS (e.g., the CIELAB or CIEXYZ color space). Additionally, an ICC profile can include different sets of tables for different rendering intents. Examples of rendering intents include the following: perceptual, relative colorimetric, absolute colorimetric, and saturation. Depending on which rendering intent is to be used to form an image, one of the sets of tables is selected when printing. An ICC profile may also include other information.

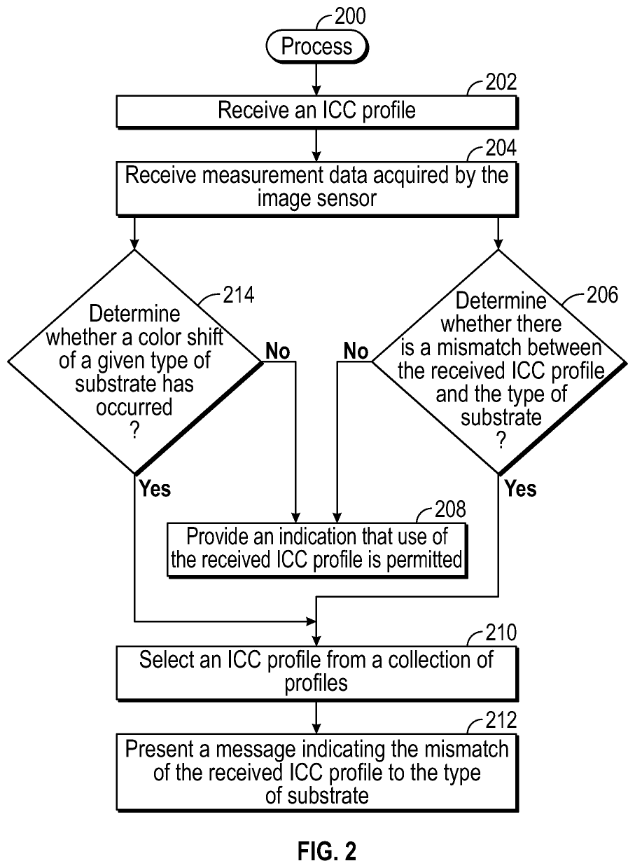

Referring further to FIG. 2, which shows a flow diagram of a process 200 according to some examples, the ICC profile mismatch remediation engine 104 can perform the tasks of FIG. 2. The process 200 can be part of a calibration process or test process that is performed to ensure that settings and a configuration of the printer 102 are as expected, including that an ICC profile to be used for printing is matched to a given substrate or given type of substrate onto which images are to be formed.

The ICC profile mismatch remediation engine 104 receives (at 202) an ICC profile (e.g., 114 in FIG. 1) to be used to print an image onto a substrate, such as the substrate 106. In some examples, the received ICC profile is for use in printing onto a specific type of substrate (or specific types of substrates), such as a type of textile or other substrate. Generally, different ICC profiles may be used for different types of substrates.

In some examples, the ICC profile mismatch remediation engine 104 further receives (at 204) measurement data 116 that has been acquired by the image sensor 110 of an image formed on the substrate 106. The image formed on the substrate 106 can include a calibration pattern, such as a pattern of patches of different colors, that has been printed by the printer 102 onto the substrate 106 as part of the calibration process 200. The measurement data 116 is received from the image sensor 110 and is provided by the printer controller 112 to the ICC profile mismatch remediation engine 104.

In some examples, the image sensor 110 may be calibrated, such as based on a color white patch, to ensure that the measurement data 116 provides an accurate representation of colors.

The ICC profile mismatch remediation engine 104 also has access to a repository 118 that stores historical data 120 for a given type of substrate. The historical data 120 may include an ICC profile (or multiple ICC profiles) 122 that has (have) been used in the past (such as by the printer 102) to print images onto substrates of the given type of substrate.

Multiple historical data including respective ICC profile(s) can also be stored in the repository 118 for multiple corresponding types of substrates.

ICC profiles 122 that have been used in the past to print to a given type of substrate, such as the type of substrate corresponding to the substrate 106. In some cases, the repository 118 can store different collections of historical ICC profiles 122 for different types of substrates. The repository 118 can be implemented using a storage device (or multiple storage devices), such as a disk-based storage device, a solid state storage device, a memory device, and so forth. The repository 118 may be included in the printer 102 or may be external of the printer 102.

The ICC profile mismatch remediation engine 104 determines (at 206) whether there is a mismatch between the received ICC profile 114 to be used for printing by the printer 102, and the substrate 106 (or more specifically, a type of the substrate 106) that is to be used by the printer 102. This mismatch detection can be performed in one of several ways. In some examples, the ICC profile mismatch remediation engine 104 can compare color information derived from the ICC profile 114 and color information in the measurement data 116 received from the image sensor 110. In examples where the image sensor 110 is a spectrophotometer, the measurement data 116 can include L*a*b* values of an image (e.g., a calibration pattern) printed on the substrate 106.

For example, the color information derived from the ICC profile 114 can be generated by a color space conversion calculator 124 in response to a request from the ICC profile mismatch remediation engine 104. In some examples, the color space conversion calculator 124 is part of an open-source color management system, including the little CMS (LCMS). Note that the LCMS may be implemented as part of the printer controller 112 in some examples.

Although reference is made to a specific color management system in the present discussion, it is noted that other types of color management systems can be employed, including other open-source color management systems or proprietary color management system.

The color space conversion calculator 124 can include a “transicc” module included in the LCMS. As another example, the color space conversion calculator 124 can include a “wtpt” module included in the LCMS.

The color space conversion calculator 124 is able to produce specific values in any color space, which can be translated to L*a*b* values using the ICC profile 114. To obtain the darkest point and/or whitest point of the ICC profile 114, the ICC profile mismatch remediation engine 104 can request the color space conversion calculator 124 to return L*a*b* value(s) corresponding to the darkest point (pure black) or whitest point (pure white). The ICC profile mismatch remediation engine 104 can provide various inputs to the color space conversion calculator 124, including a name (e.g., a pathname) of the ICC profile 114, a rendering intent to be used, and other input parameters.

In other examples, other types of color space conversion calculators can be used by the ICC profile mismatch remediation engine 104 to obtain color information (e.g., L*a*b* values) for the darkest point and the whitest point of the ICC profile 114.

The ICC profile mismatch remediation engine 104 can compare the color information derived from the ICC profile 114 by the color space conversion calculator 124 to respective color information in the measurement data 116. The color information compared can include color information (e.g., L*a*b* values) for pure black and/or color information (e.g., L*a*b* values) for pure white.

Another way to detect a mismatch between the ICC profile 114 and the type of the substrate 106 is to compare color information derived from the ICC profile 114 to color information derived from ICC profile(s) 122 in the historical data 120. The color information compared can include L*a*b* values for pure black and/or pure white computed by the color space conversion calculator 124 based on the ICC profile 114 and the ICC profile(s) 122.

In examples where there are multiple ICC profiles 122 in the historical data 120, the color space conversion calculator 124 can return multiple color information for pure black and/or pure white for the respective multiple ICC profiles 122. In this case, the ICC profile mismatch remediation engine 104 can calculate an average or some other mathematical aggregate of the color multiple color information for the respective multiple ICC profiles 122.

As part of determining (at 206) whether there is a mismatch between the received ICC profile 114 and the type of the substrate 106, the ICC profile mismatch remediation engine 104 can determine whether a difference between the color information derived from the ICC profile 114 and the color information for the type of the substrate 106 exceeds a specified threshold. As noted above, the color information for the type of the substrate 106 can include either (1) color information of the measurement data 116, or (2) color information derived from the ICC profile(s) 122 in the historical data 120.

The specified threshold can be expressed as a distance metric ΔE between colors, such as colors in the L*a*b* color space. The specific threshold used can be based on empirical data collected from past measurements. For example, the specified threshold can be an aggregate value (e.g., average, mean, etc.) derived from color information (white color points, black color points, etc.) of images previously formed on substrates according to the type of substrate.

If the difference between the color information derived from the ICC profile 114 and the color information for the type of the substrate 106 does not exceed the specified threshold, then the ICC profile 114 is appropriate for the type of the substrate 106, and the printer 102 is allowed to proceed to use the ICC profile 114 in printing operations on the type of the substrate 106. For example, the ICC profile mismatch remediation engine 104 can provide (at 208) an indication to the printer controller 112 that use of the ICC profile 114 is permitted for the type of the substrate 106.

However, if the difference between the color information derived from the ICC profile 114 and the color information for the type of the substrate 106 exceeds the specified threshold, then the ICC profile mismatch remediation engine 104 can take remediation actions. For example, the ICC profile mismatch remediation engine 104 can select (at 210) an ICC profile from a collection of ICC profiles to use in print operations by the printer 102. Note that the “collection” can include a single ICC profile or multiple ICC profiles.

For example, the collection of ICC profiles can include the ICC profile(s) 122 in the historical data 120.

As another example, the printer 102 may include a repository 126 that stores ICC profiles 128. The ICC profiles 128 may include generic ICC profiles that are shipped with the printer 102. Alternatively, the ICC profiles 128 may have been downloaded to the printer 102, either at the request of a user or automatically by the printer 102. In such examples, the ICC profile mismatch remediation engine 104 can select an ICC profile from the ICC profiles 128.

In further examples, the ICC profile mismatch remediation engine 104 may be able to access ICC profiles at a remote location, such as a server or a cloud. The ICC profile mismatch remediation engine 104 can select an ICC profile from the ICC profiles at the remote location.

In some examples, the ICC profile mismatch remediation engine 104 can use color information in the measurement data 116 to search for an ICC profile in the collection of ICC profiles (e.g., the historical data 120, the ICC profiles 128, or ICC profiles at the remote location) that is associated with color information that matches the color information of the measurement data 116, to within some threshold.

Assuming there are multiple ICC profiles in the collection, the ICC profile mismatch remediation engine 104 can compare the color information derived from each of the multiple ICC profiles to the color information of the measurement data 116. The ICC profile mismatch remediation engine 104 can select the ICC profile with color information that most closely matches the color information of the measurement data 116.

The selected ICC profile would be more likely to produce expected colors when printing images onto the type of the substrate 106.

Another remediation action that can be performed by the ICC profile mismatch remediation engine 104 includes presenting (at 212) a message indicating the mismatch of the received ICC profile 114 to the type of the substrate 106 has been detected. The message can be displayed in a user interface, such as the user interface of the printer 102 or a user interface of a user computer coupled to the ICC profile mismatch remediation engine 104.

The ICC profile mismatch remediation engine 104 can also detect whether color characteristics of substrates of a given type have drifted over time such an ICC profile for the given type of substrate would no longer produce target color results. The ICC profile mismatch remediation engine 104 can determine (at 214) whether a color shift of the given type of substrate has occurred by determining whether the color information of the measurement data 116 differs from previously stored color information for the given type of substrate by greater than a given threshold. For example, the ICC profile mismatch remediation engine 104 can store the color information for the given type of substrate at a first time that a substrate of the given type is used in a print operation by the printer 102. At a later time, the ICC profile mismatch remediation engine 104 can compare color information for another substrate of the given type to the stored color information.

If the color information of the measurement data 116 differs from the previously stored color information for the given type of substrate by greater than the given threshold, then there has been an excessive shift in the color characteristics of the substrate 106 loaded, and a remediation action would have to be performed, including task 210 and/or task 212.

If the color information of the measurement data 116 does not differ from the previously stored color information for the given type of substrate by greater than the given threshold, then the ICC profile mismatch remediation engine 104 can provide (at 208) the indication that use of the received ICC profile 114 is permitted.

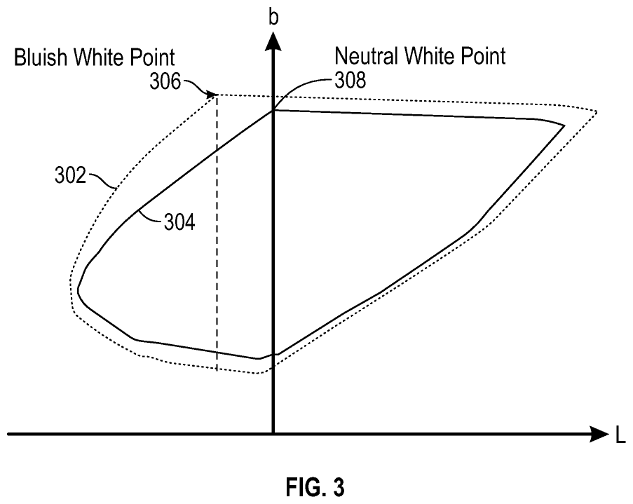

FIG. 3 illustrates a gamut 302 of a first ICC profile (e.g., the ICC profile 114) and a gamut 304 of a second ICC profile (e.g., an ICC profile 122 or another ICC profile). The gamuts 302 and 304 are plotted in the L-b plane (x axis represents L values of the L*a*b* color space, and y axis represents the b values of the L*a*b* color space).

A point 306 of the gamut 302 represents the L-b value of the whitest point of the gamut 302, and a point 308 of the gamut 304 represents the L-b value of the whitest point of the gamut 304. The point 306 corresponds to a white color that has a bluish tint, and the point 308 represents a neutral white point (pure white). A comparison of the color information represented by the points 306 and 308 reveals that the first ICC profile may not produce expected color results when used by the printer 102 to print images on the substrate 106.

Additionally, each of the gamuts 302 and 304 has a respective gamut volume, which is defined by the ranges of possible L*a*b* values of each gamut. As part of the determination (at 206 in FIG. 2) of whether there is a mismatch between the received ICC profile 114 and the type of the substrate 106, the ICC profile mismatch remediation engine 104 can also compare the gamut volume of the ICC profile 114 and the gamut volume of a previous ICC profile used to print on the same type of substrate. If the gamut volumes differ by greater than a specified extent, that is an indication that there is a mismatch.

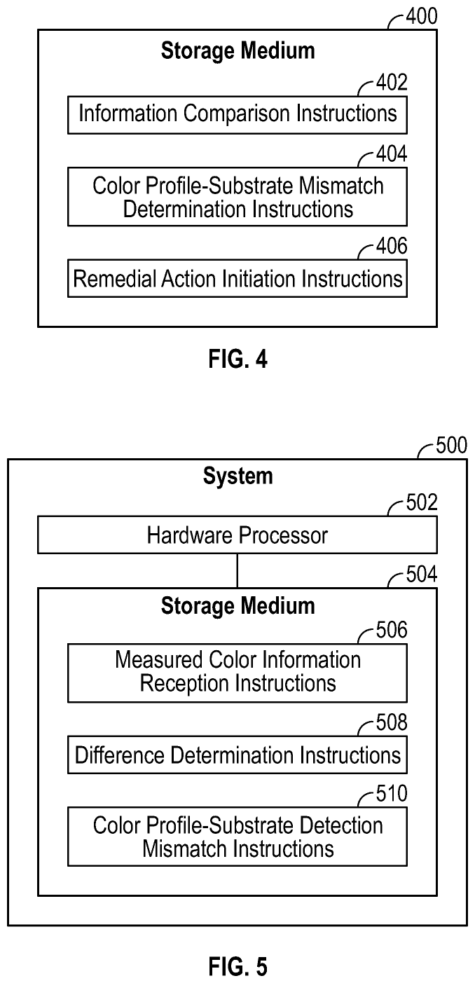

FIG. 4 is a block diagram of a non-transitory machine-readable or computer-readable storage medium 400 storing machine-readable instructions that upon execution cause a system (e.g., the printer 102 of FIG. 1 or a separate computer) to perform various tasks.

The machine-readable instructions include information comparison instructions 402 to compare information of a color profile for an imaging device to color information relating to a type of substrate on which an image is to be formed. The information of the color profile to be compared can include color information (e.g., whitest point, darkest point, etc.) derived from the color profile, such as by using the color space conversion calculator 124 of FIG. 1.

The color information relating to the type of substrate that is compared can include measured color information of the image formed on a substrate, such as the measurement data 116 (FIG. 1) acquired by the image sensor 110 (FIG. 1). Alternatively, the color information relating to the type of substrate that is compared can include information of past color profile(s) used in forming images on substrates according to the type of substrate, such as color information derived from the past color profile(s) using the color space conversion calculator 124.

The machine-readable instructions include color profile-substrate mismatch determination instructions 404 to, based on the comparing, determine a mismatch between the color profile and the type of substrate.

The machine-readable instructions include remedial action initiation instructions 406 to initiate a remedial action (e.g., 210 and/or 212 in FIG. 2) to address the mismatch.

In further examples, the machine-readable instructions can record first color information (e.g., whitest point and/or darkest point) based on a measurement of an image formed, using the color profile, on a first substrate according to the type of substrate, the recorded first color information for use in identification of a color drift issue of the imaging device when forming images on substrates according to the type of substrate (e.g., task 214 in FIG. 2).

In further examples, the machine-readable instructions can compare, to the first color information, second color information based on a measurement of an image formed, using the color profile, on a second substrate according to the type of substrate, and identify the color drift issue based on the comparing of the second color information to the first color information (e.g., task 214 in FIG. 2).

FIG. 5 is a block diagram of a system 500 according to some examples. The system 500 can include the printer 102 of FIG. 1, or a computer(s) separate from the printer 102.

The system 500 includes a hardware processor 502 (or multiple hardware processors). A hardware processor can include a microprocessor, a core of a multi-core microprocessor, a microcontroller, a programmable integrated circuit, a programmable gate array, or another hardware processing circuit.

The system 500 includes a storage medium 504 storing machine-readable instructions that are executable on the hardware processor 502 to perform various tasks. Machine-readable instructions executable on a hardware processor can refer to the instructions executable on a single hardware processor or the instructions executable on multiple hardware processors.

The machine-readable instructions in the storage medium 504 include measured color information reception instructions 506 to receive measured color information (e.g., 116 in FIG. 1) of an image printed on a substrate and measured by a sensor (e.g., 110 in FIG. 1) of a printer.

The machine-readable instructions in the storage medium 504 include difference determination instructions 508 to determine a difference between the measured color information and color information of a color profile for the printer, where the color profile is for a type of substrate, and the substrate on which the image is printed is according to the type of substrate.

The machine-readable instructions in the storage medium 504 include color profile-substrate mismatch detection instructions 510 to, based on the determined difference, detect a mismatch between the color profile and the type of substrate.

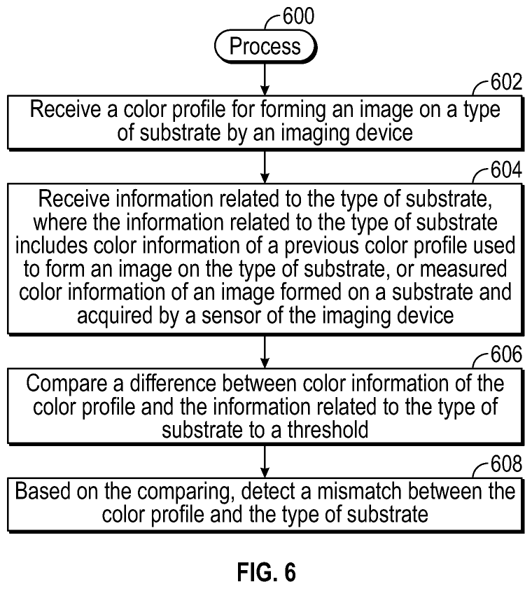

FIG. 6 is a flow diagram of a process 600 according to some examples. The process 600 can be performed by the ICC profile mismatch remediation engine 104.

The process 600 includes receiving (at 602) a color profile for forming an image on a type of substrate by an imaging device.

The process 600 includes receiving (at 604) information related to the type of substrate, where the information related to the type of substrate includes color information of a previous color profile used to form an image on the type of substrate, or measured color information of an image formed on a substrate and acquired by a sensor of the imaging device.

The process 600 includes comparing (at 606) a difference between color information of the color profile and the information related to the type of substrate to a threshold.

The process 600 includes, based on the comparing, detecting (at 608) a mismatch between the color profile and the type of substrate.

A storage medium (e.g., 400 in FIG. 4 or 504 in FIG. 5) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory or other type of non-volatile memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
compare information of a color profile for an imaging device to color information relating to a type of substrate on which an image is to be formed;
based on the comparing, determine a mismatch between the color profile and the type of substrate; and
initiate a remedial action to address the mismatch.

2. The non-transitory machine-readable storage medium of claim 1, wherein the comparing comprises comparing the information of the color profile to a measured color information of the image formed on a substrate.

3. The non-transitory machine-readable storage medium of claim 2, wherein the measured color information of the image formed on the substrate is from a sensor of the imaging device.

4. The non-transitory machine-readable storage medium of claim 1, wherein the comparing comprises comparing the information of the color profile to information of past color profiles used in forming images on substrates according to the type of substrate.

5. The non-transitory machine-readable storage medium of claim 1, wherein the information of the color profile compared to the information relating to the type of substrate comprises a whitest point.

6. The non-transitory machine-readable storage medium of claim 1, wherein the information of the color profile compared to the information relating to the type of substrate comprises a darkest point.

7. The non-transitory machine-readable storage medium of claim 1, wherein the instructions upon execution cause the system to:
determine whether a difference between color information derived from the color profile and the color information relating the type of substrate exceeds a threshold,
wherein the determining of the mismatch between the color profile and the type of substrate is based on the difference exceeding the threshold.

8. The non-transitory machine-readable storage medium of claim 7, wherein the threshold is based on an aggregate value derived from color information of images previously formed on substrates according to the type of substrate.

9. The non-transitory machine-readable storage medium of claim 1, wherein the instructions upon execution cause the system to:
record first color information based on a measurement of an image formed, using the color profile, on a first substrate according to the type of substrate, the recorded first color information for use in identification of a color drift issue of the imaging device when forming images on substrates according to the type of substrate.

10. The non-transitory machine-readable storage medium of claim 9, wherein the instructions upon execution cause the system to:
compare, to the first color information, second color information based on a measurement of an image formed, using the color profile, on a second substrate according to the type of substrate; and
identify the color drift issue based on the comparing of the second color information to the first color information.

11. A system comprising:
a processor; and
a non-transitory machine-readable storage medium comprising instructions that are executable on the processor to:
receive measured color information of an image printed on a substrate and measured by a sensor of a printer;
determine a difference between the measured color information and color information of a color profile for the printer, wherein the color profile is for a type of substrate, and the substrate on which the image is printed is according to the type of substrate; and
based on the determined difference, detect a mismatch between the color profile and the type of substrate.

12. The system of claim 11, wherein the system is included within the printer or is separate from the printer.

13. The system of claim 11, wherein measured color information is from the sensor that is capable of self-calibration.

14. A method of a system comprising a hardware processor, comprising:
receiving a color profile for forming an image on a type of substrate by an imaging device;
receiving information related to the type of substrate, wherein the information related to the type of substrate comprises color information of a previous color profile used to form an image on the type of substrate, or measured color information of an image formed on a substrate and acquired by a sensor of the imaging device;
comparing a difference between color information of the color profile and the information related to the type of substrate to a threshold; and
based on the comparing, detecting a mismatch between the color profile and the type of substrate.

15. The method of claim 14, further comprising:
recording first color information based on a measurement of an image formed, using the color profile, on a first substrate according to the type of substrate;
comparing, to the first color information, second color information based on a measurement of an image formed, using the color profile, on a second substrate according to the type of substrate; and
identifying a color drift issue based on the comparing of the second color information to the first color information.
